(19) United States
(12) Patent Application Publication
(10) Pub. No.: US 2025/0091644 A1
(43) Pub. Date: Mar. 20, 2025

(54) VEHICLE FLOOR SHEET METAL ARRANGEMENT

(71) Applicant: BENTELER AUTOMOBILTECHNIK GMBH, Paderborn (DE)

(72) Inventors: Georg FROST, Steinheim (DE); Christian HIELSCHER, Delbrueck (DE); Andreas HITZ, Erwitte (DE); Paul KAUPMANN, Anroechte (DE); Mathias LOHBERG, Altenbeken (DE); Joern TOELLE, Paderborn (DE)

(21) Appl. No.: 18/884,402

(22) Filed: Sep. 13, 2024

(30) Foreign Application Priority Data
Sep. 14, 2023 (DE) 102023124895.2

(51) Int. Cl. B62D 21/10; B60K 1/04; B62D 21/15

(52) U.S. Cl. CPC B62D 21/10; B60K 1/04; B62D 21/157; B60K 2001/0438

(57) ABSTRACT

A vehicle floor sheet metal arrangement with a vehicle floor sheet metal as a component of a motor vehicle body, which has a flat floor region and a deformation on two opposite longitudinal sides and two opposite end sides, such that a vehicle floor sheet metal is formed that is arranged between two sills. In the flat floor region, at least one downward-facing molded recess is formed in the vertical direction (Z) of the motor vehicle, and the vehicle floor sheet metal is manufactured in one piece in a single press stroke, with regions of mutually different wall thickness and/or mutually different tensile strength Rm.

### RELATED APPLICATIONS

The present application claims priority of German Application Number 10 2023 124 895.2 filed Sep. 14, 2023, the disclosure of which is hereby incorporated by reference herein in its entirety.

### FIELD

The present disclosure relates to a vehicle floor sheet metal arrangement having a vehicle floor sheet metal for installation or integration in a motor vehicle body.

### BACKGROUND

Motor vehicle bodies are used in motor vehicles, for example, passenger vehicles. The passenger vehicles are driven by a combustion engine drive, but increasingly also by an electric drive.

Such a self-supporting body is made of individual sheet metal components produced by forming. These sheet metal components are able to be made of steel sheet metal alloys, but in other cases also of aluminum components. For this purpose, individual components, such as an A-pillar, a B-pillar, a C-pillar, various longitudinal members or cross members, are produced individually and then joined together by welding to form the self-supporting body.

Hot forming and press curing technology is also used for individual components, which results in tensile strengths of more than 1,000 MPa in a curable steel alloy. A floor sheet metal, for example, is described in DE 10 2004 037 789 B3.

### SUMMARY

The object of the present disclosure is to provide a vehicle floor sheet metal able to be manufactured in a way that is simple in terms of production technology and also cost-effective in terms of its manufacturing costs, that is improved in its geometric precision and that has various connection options for additional components as well as the specific setting of crash properties.

The aforementioned object is achieved in a vehicle floor sheet metal arrangement according to the embodiments discussed below.

The vehicle floor arrangement includes a vehicle floor sheet metal that serves as an integral component of a material-connected motor vehicle body. The vehicle floor sheet metal is produced in a single piece by means of metal-forming technology and then inserted into a self-supporting motor vehicle body or welded thereto. For this purpose, the vehicle floor sheet metal has a flat floor and a deformation on two opposite longitudinal sides and two opposite end sides. The deformation refers to the vertical direction of the motor vehicle and is designed as a flange, at least in portions.

A flat floor means that a floor structure is formed. However, a flat floor in the sense of the present disclosure does not mean that the floor is completely planar or flat.

According to the present disclosure, at least one downwardly directed molded recess is formed in the floor region in relation to the vertical direction of the motor vehicle. The vehicle floor sheet metal itself is manufactured in one piece in a single press stroke and has regions of different wall thickness and/or different tensile strength Rm.

In the present disclosure, “single-piece” or “single-part” means that a sheet metal blank is formed in a so-called large-capacity press. This sheet metal blank itself is able to, for example, be a tailored welded blank, i.e. a blank made from different sheet metal portions welded together, which is then formed as a single sheet metal blank in a large-capacity press. This measure improves the geometric precision of the entire vehicle floor sheet metal in both the longitudinal and transverse directions of the motor vehicle.

The vehicle floor sheet metal has regions with different tensile strength Rm and/or different wall thickness. This measure is able to be used to provide higher strength in locally required regions, for example, by means of a higher wall thickness and/or higher strength when using hot forming and press curing technology as higher tensile strength, compared to other directly adjacent regions. These then have a softer material structure and are able to be referred to as soft zones. The regions with higher strength have a tensile strength greater than 1000 MPa, greater than 1350 MPa, greater than 1500 MPa, or greater than 1800 MPa. The regions with a softer material structure have a tensile strength Rm of less than 1000 MPa, or between 500 and 850 MPa.

In at least one embodiment of the present disclosure, regions which have connection strengths are able to be reinforced, for example, a molded cross member running transversely to the direction of travel. In at least one embodiment of the present disclosure, this also serves as a seat cross member. The seat cross member is able to be formed in its own cross-section as a hollow component. The seat cross member then has a higher tensile strength and/or greater wall thickness than adjacent regions. In at least one embodiment of the present disclosure, in the case of a seat cross member that has a hollow cross-section, a sheet metal blank is able to be designed as a tailored welded blank, in which a sheet metal blank part is a component with a hollow cross-section. The hollow component is then formed in the forming press. This seat cross member simultaneously serves to stiffen the vehicle body produced and to stiffen the passenger compartment, for example, in the event of a side impact. The seat cross member is able to be closed from below by a closure sheet metal, either partially or completely.

The sheet metal blank itself is able to designed as a single piece made of a single material. For example, this sheet metal blank is able to be designed as a tailored rolled blank. However, a sheet metal blank is able to be produced as a tailored welded blank, in which individual sheet metal blanks with different wall thicknesses and/or different material structures are welded together. Here, sheet metal blanks are able to be placed abutting against each other and laser welded, for example. However, the sheet metal blanks are able to overlap and be spot welded.

Further longitudinal and/or cross members are able to be formed into the vehicle floor sheet metal. This measure is able to be used to reinforce the entire floor region.

In at least one embodiment of the present disclosure, however, the vehicle floor sheet metal is used for an electric vehicle. This electric vehicle has energy storage devices in the form of batteries or drive batteries in its floor region; for example, these drive batteries are inserted into the recess or recesses.

In at least one embodiment of the present disclosure, a drive battery is placed from below the vehicle floor sheet metal in the vertical direction of the motor vehicle and thus inserted between two recesses. The respective vehicle battery or drive battery or the corresponding recess is then closed by a cover.

The overall dimension of the floor sheet metal is therefore more than 80×100 cm, or more than 90 cm×150 cm. The vehicle floor sheet metal or floor sheet metal extends essentially from one sill to the opposite sill in the motor vehicle body in the transverse direction of the motor vehicle body. Relative to the longitudinal direction of the motor vehicle, the vehicle floor sheet metal extends from a front wall or firewall in the front region of the motor vehicle to a rear seat near the rear region of the motor vehicle.

The latter, i.e., the back seat cushion, is coupled to the vehicle floor sheet metal. In at least one embodiment of the present disclosure, the back seat support is formed directly with the floor sheet metal. In at least one embodiment of the present disclosure, the back seat support is designed in one piece, for example, in one piece with the vehicle floor sheet metal, and then directly formed on a large-capacity press. This also increases the precision of the manufactured component while simultaneously reducing production costs.

In at least one embodiment of the present disclosure, at least two recesses are arranged one behind the other in the longitudinal direction of the motor vehicle. Alternatively or additionally, two recesses are arranged next to each other in at least one row in relation to the transverse direction of the motor vehicle. At least two recesses are arranged next to each other in each row.

This measure elaborates on the placement possibilities of the drive batteries.

This also allows individual recesses to be used differently. A drive battery is able to be arranged in a recess, for example in the front region in front of the driver's seat and passenger seat. A drive battery is able to be arranged here. In the region of the rear seat, the recesses are then designed to be empty and be used as a foot space recess for passengers sitting in the rear seat.

In at least one embodiment of the present disclosure, smaller recesses are formed in each case, which are then each closed with a cover, and permits the cover to be removed reversibly in the finished motor vehicle body, for maintenance purposes or to replace a drive battery, for example. The covers are tightly sealed to the respective recess.

In at least one embodiment of the present disclosure, the front and rear recesses are the same depth. Alternatively, the front and rear recesses have different depths.

### BRIEF DESCRIPTION OF THE DRAWINGS

Further advantages, features, characteristics and aspects of the present disclosure are the subject of the following description. Various embodiments are shown in schematic figures. They serve to facilitate an understanding of the present disclosure. In particular:

FIG. 1 shows an underbody sheet metal for use in a motor vehicle body according to at least one embodiment,

FIG. 2A to FIG. 2C respectively show a plan view, cross-sectional view, and alternate view according to at least one embodiment,

FIG. 3A to FIG. 3C respectively_show a plan view, cross-sectional view, and alternate view according to at least one embodiment,

FIG. 4A to FIG. 4E respectively show a first plan view, second plan view, cross-sectional view, a first alternate view, and a second alternate view according to at least one embodiment,

FIG. 5A to FIG. 5E respectively show a first plan view, second plan view, cross-sectional view, a first alternate view, and a second alternate view according to at least one embodiment, and

FIG. 6A to FIG. 6C respectively show a plan view, cross-sectional view, and alternate view according to at least one embodiment.

### DETAILED DESCRIPTION

The same reference numerals are used in the figures for the same or similar components, even if a repeated description is omitted for reasons of simplification.

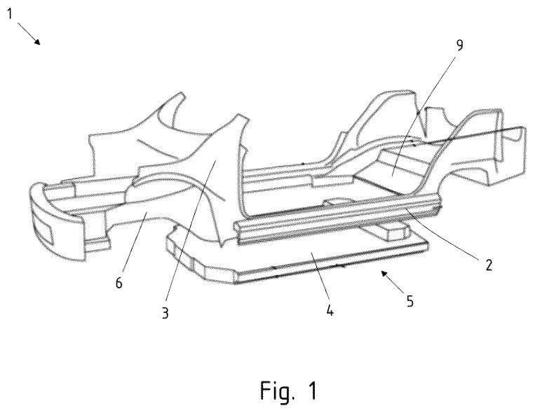

FIG. 1 shows a motor vehicle body 1. An A-pillar 3, which is indicated at the front is able to be recognized in a partial section. A vehicle floor sheet metal 4 is attached below the motor vehicle body 1, so that a vehicle floor sheet metal arrangement 5 is thus realized. Furthermore, opposing longitudinal members are formed, as well as a rear seat support 9 in the rear region. The sills 2 are arranged on the outside.

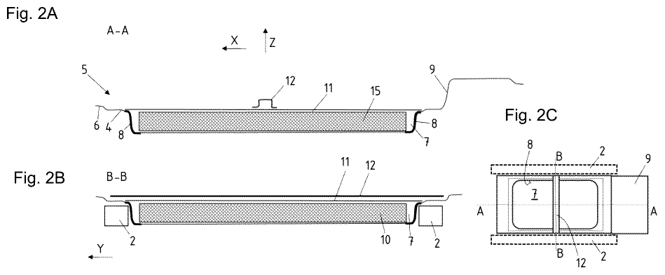

FIG. 2A and FIG. 2B show a longitudinal section view and a cross-sectional view according to section line A-A and D-D of FIG. 2C.

The vehicle floor sheet metal arrangement 5 has a vehicle floor sheet metal. The vehicle floor sheet metal 4 has a protruding flange 6 at the front relative to the longitudinal direction X of the motor vehicle. Furthermore, a recess is formed. This is shaped so the flange points downwards in the vertical direction Z of the motor vehicle. The resulting wall 8 of the recess 7 runs all the way around the recess 7 and, as shown, has a greater wall thickness and/or greater tensile strength than the other regions of the vehicle floor sheet metal 4. The wall-shaped section itself then runs around the recess. The wall itself is oriented in the vertical direction of the motor vehicle and runs around the recess. Furthermore, a rear seat support 9 is also formed in the rear region. This is integrally formed with the vehicle floor sheet metal 4. In the recess 7 itself, a drive battery 10 is arranged, as well as a cover 11 that closes the recess. A seat cross member 12 shown here is arranged on the cover 11, which cross member, according to the plan view in FIG. 2A, extends from one side of the motor vehicle body 1 to an opposite side, and thus from one sill 2 to the opposite sill 2.

FIG. 2B shows a cross-sectional view according to section line B-B. With respect to the transverse direction Y of the motor vehicle, the recess 7 extends from one side of a sill 2 to the opposite side. A wide-area drive battery 10 is arranged therein.

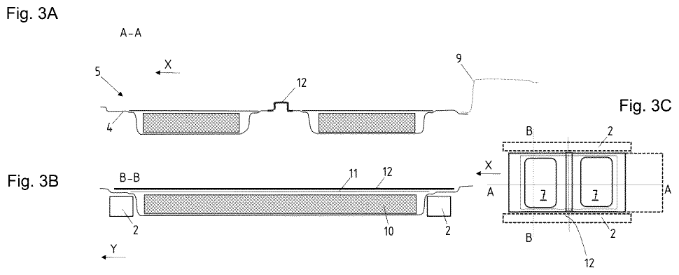

FIG. 3A and FIG. 3B show an alternative embodiment variant to FIG. 2A to FIG. 2C. The main difference is that, in relation to the longitudinal direction X of the motor vehicle, two recesses are arranged one behind the other and, for example, the seat cross member 12 is integrally formed with the vehicle floor sheet metal 4. The seat cross member 12 itself is also designed as a component with a hollow cross-section. The back seat support 9 is hereby formed itself and is coupled to the actual vehicle floor sheet metal 4 only after the forming process. However, the back seat support 9 is able to be formed directly with the vehicle floor sheet metal 4. According to the cross-sectional view of FIG. 3B, the drive battery extends from one side to the opposite side. In the longitudinal direction of the motor vehicle X according to FIG. 3A, however, this is interrupted so that a respective recess 7 of the footwell of the front seats and a recess 7 are arranged below the footwell of the rear seat.

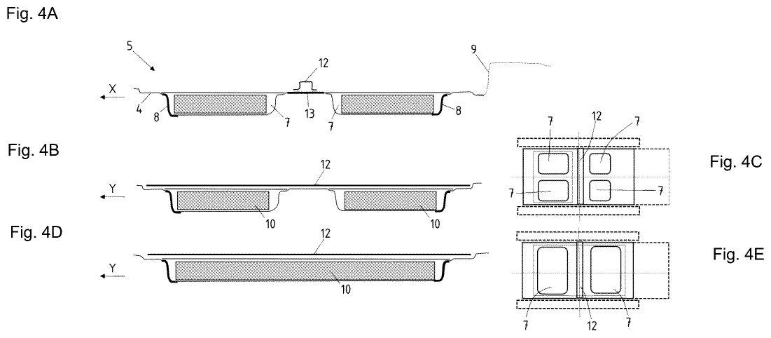

FIG. 4A to FIG. 4E show an alternative embodiment variant. In the case of FIG. 4A, FIG. 4B, and FIG. 4C, two recesses 7 are respectively arranged one behind the other in the longitudinal direction of the motor vehicle X and two recesses 7 are arranged next to each other in the transverse direction of the motor vehicle Y. In the case of FIG. 4A, FIG. 4D, and FIG. 4E, two recesses 7 are arranged in the longitudinal direction of the motor vehicle X one behind the other, which extend over substantially the entire width in the transverse direction of the motor vehicle Y. According to the cross-sectional view, the peripheral wall 8 is also reinforced here, but not the inner wall below the seat cross member 12. The part below the seat cross member 12 in the form of a center portion 13 also has a greater wall thickness and/or greater tensile strength and extends across the entire width in the transverse direction Y of the motor vehicle. In the case of FIG. 4B and FIG. 4C, four drive batteries 10 are able to be arranged. In the case of FIG. 4D and FIG. 4E, two drive batteries 10 are arranged in the respective recess. The rear wall sheet metal is able to be formed in one piece with the vehicle floor sheet metal 4. However, the rear wall sheet metal is able to be manufactured individually and then joined to the vehicle floor sheet metal 4.

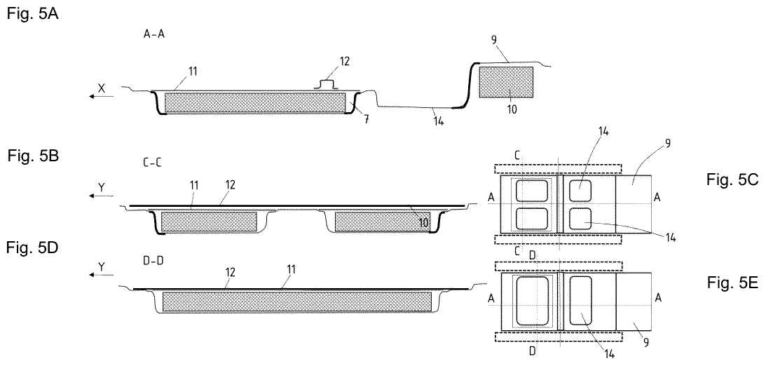

FIG. 5A to FIG. 5E show a further embodiment variant of the present disclosure. According to FIG. 5A, FIG. 5B, and FIG. 5C, the recess 7 is designed as a battery recess at the front in the longitudinal direction X of the motor vehicle and has a greater longitudinal extent in the longitudinal direction X of the motor vehicle than the recess located behind the battery recess, which is designed as a footwell recess 14 for rear-seat passengers. This footwell recess 14 is able to, for example, be designed in two parts in the transverse direction of the motor vehicle, as shown in FIG. 5C. However, the footwell recess 14 is able to be designed in one piece in the transverse direction of the motor vehicle, as in the case of FIG. 5E in the transverse direction Y of the motor vehicle, and thus extend across the width of the motor vehicle. In this embodiment variant, the rear seat sheet metal is able to be formed at the same time. A further drive battery 10 is able to be arranged below the rear seat sheet metal. The drive battery is closed by a cover 17.

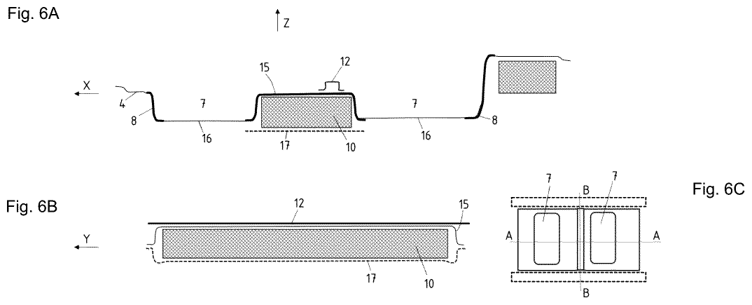

FIG. 6A to FIG. 6C show a further embodiment variant of the present disclosure. Here, also, two recesses 7 are formed in the longitudinal direction X of the motor vehicle, as shown in FIG. 2A, which are spaced apart from each other. In relation to the vertical direction Z of the motor vehicle, a drive battery is inserted from below. The region 15 between the recesses 7, which extends over the drive battery like a hood, has a greater wall thickness and tensile strength range than the bottom 16 of the recess 7 itself. The wall of the recess 7 also has a higher tensile strength. From below, the drive battery is then closed with a cover 17.

The steel grades used are able to be used subsequently as examples and for all variants of this present disclosure. In at least one embodiment of the present disclosure, different steel grades are able to be combined with each other in a tailored welded blank. Corresponding strength ranges for hard or soft regions or solid or ductile regions are able to be found in the table. All alloy components are given in weight percent, with the addition of residual iron and impurities resulting from the smelting process to the respective curable steel alloy.

| 1 | | C | | Si | | Mn | | P | | S | | Al | | B | | Cr | |
|---|---|---|---|---|---|---|---|---|---|---|---|---|---|---|---|---|---|
| 2 | TWB-Ab [symbol] chnitt [symbol] us | min | max | min | max | min | max | min | max | min | max | min | max | min | max | min | max |
| 3 | [symbol] > | 0.19 | 0.25 | 0.1 | 0.4 | 1.1 | 1.4 | | 0.02 | | 0.005 | 0 | 0.06 | 0.001 | 0.005 | | 0.2 |
| | 1350 MPa | | | | | | | | | | | | | | | | |
| 4 | [symbol] | 0.2 | 0.23 | 0.2 | 0.3 | 1.1 | 1.4 | | 0.02 | | 0.006 | 0 | 0.06 | 0.002 | 0.004 | 0.1 | 0.3 |
| | 1500 MPa | | | | | | | | | | | | | | | | |
| 5 | [symbol] > | 0.31 | 0.37 | 0.1 | 0.6 | 1 | 1.5 | | 0.025 | | 0.02 | | 0.1 | 0.001 | 0.004 | 0.06 | 0.35 |
| | 1750 MPa | | | | | | | | | | | | | | | | |
| 6 | [symbol] | 0.33 | 0.35 | 0.15 | 0.35 | 1 | 1.5 | | 0.0 [symbol] | | 0.025 | 0.01 | 0.08 | 0.001 | 0.004 | 0.06 | 0.5-Mo |
| | 1300 MPa | | | | | | | | | | | | | | | | |
| 7 | [symbol] > | 0.06 | 0.13 | | 0.7 | | 1.9 | | 0.05 | | 0.05 | | 0.1 | | 0.003 | | 0.15 |
| | 450 MPa | | | | | | | | | | | | | | | | |
| 8 | [symbol] | 0.07 | 0.11 | 0.02 | 0.6 | 1.2 | 1.8 | | 0.03 | | 0.01 | 0.01 | 0.07 | 0.0007 | 0.002 | | 0.15 |
| | 100-1000 MPa | | | | | | | | | | | | | | | | |

| 1 | | Cu | | N | | Nb | | Ni | | Ti | | V | | Mo | |
|---|---|---|---|---|---|---|---|---|---|---|---|---|---|---|---|
| 2 | TWB-Ab [symbol] chnitt [symbol] us | min | max | min | max | min | max | min | max | min | max | min | max | min | max |
| 3 | [symbol] > | | 0.1 | | | | 0.05-Ti | 0.1 | 0.02 | 0.01 | 0.1 | | | | 0.35 |
| | 1350 MPa | | | | | | | | | | | | | | |
| 4 | [symbol] | | 0.1 | | 0.01 | | 0.05-Ti | 0.1 | 0.02 | 0.02 | 0.05 | | 0.01 | | 0.35 |
| | 1500 MPa | | | | | | | | | | | | | | |
| 5 | [symbol] > | | 0.2 | | 0.2 | | 0.1 | | 0.2 | 0.002 | 0.05 | | | | 0.35 |
| | 1750 MPa | | | | | | | | | | | | | | |
| 6 | [symbol] | | 0.2 | | 0.2 | 0.01 | 0.05 | | 0.2 | 0.005 | 0.015 | | 0.01 | | 0.5-Cr |
| | 1300 MPa | | | | | | | | | | | | | | |
| 7 | [symbol] > | | 0.2 | | 0.2 | | 0.1 | | | | 1.2 | | 0.1 | | 0.1 |
| | 450 MPa | | | | | | | | | | | | | | |
| 8 | [symbol] | | 0.2 | | 0.2 | 0.04 | 0.1 | | | 0.03 | 0.2 | | 0.1 | | 0.1 |
| | 100-1000 MPa | | | | | | | | | | | | | | |

[symbol]

indicates data missing or illegible when filed

The foregoing description of some embodiments of the disclosure has been presented for purposes of illustration and description. The description is not intended to be exhaustive or to limit the disclosure to the precise form disclosed, and modifications and variations are possible in light of the above teachings. The specifically described embodiments explain the principles and practical applications to enable one ordinarily skilled in the art to utilize various embodiments and with various modifications as are suited to the particular use contemplated. Various changes, substitutions and alterations are able to be made hereto without departing from the spirit and scope of the disclosure.

1-11. (canceled)

12. A vehicle floor sheet metal arrangement, comprising:
a vehicle floor sheet metal as an integral component of a motor vehicle body, the vehicle floor sheet metal comprising:
a flat floor region; and
a deformation on two opposite longitudinal sides and two opposite end sides,
wherein the vehicle floor sheet metal is arranged between two sills,
wherein the flat floor region comprises at least one downwardly directed molded recess in a vertical direction of the motor vehicle body, and
wherein the vehicle floor sheet metal is integrally formed with regions having at least one of
mutually different wall thicknesses, or
mutually different tensile strengths.

13. The vehicle floor sheet metal arrangement according to claim 12, wherein the vehicle floor sheet metal is a hot-formed and press-cured component produced in a single press stroke.

14. The vehicle floor sheet metal arrangement according to claim 12, wherein a high-strength region of the vehicle floor sheet metal has a tensile strength greater than or equal to 1350 MPa.

15. The vehicle floor sheet metal arrangement according to claim 12, wherein a soft region of the vehicle floor sheet metal has a tensile strength of less than 1000 MPa.

16. The vehicle floor sheet metal arrangement according to claim 12, wherein the vehicle floor sheet metal extends from one sill of the sills to an opposite sill of the sills in a transverse direction of the motor vehicle body, and wherein an outwardly oriented, projecting flange of the vehicle floor sheet metal rests or bears on the respective sill and is joined thereto.

17. The vehicle floor sheet metal arrangement according to claim 12, further comprising:
a cover, wherein a drive battery is arranged in the at least one recess, and wherein the at least one recess is closed by the cover.

18. The vehicle floor sheet metal arrangement according to claim 12, further comprising:
a rear seat sheet metal arranged at a rear of the vehicle floor sheet metal in a longitudinal direction of the motor vehicle body.

19. The vehicle floor sheet metal arrangement according to claim 12, wherein a wall-shaped, vertically running region of the at least one recess has at least one of a higher tensile strength or a greater wall thickness than other regions of the vehicle floor sheet metal.

20. The vehicle floor sheet metal arrangement according to claim 12, wherein the at least one recess comprises at least one of
at least two recesses arranged one behind the other in a longitudinal direction of the motor vehicle body, or
at least two recesses arranged one beside the other in a transverse direction of the motor vehicle body.

21. The vehicle floor sheet metal arrangement according to claim 12, wherein
the at least one recess comprises two recesses, and
a drive battery is arranged on the vehicle floor sheet metal from below between the two recesses with respect to the vertical direction of the motor vehicle body.

22. The vehicle floor sheet metal arrangement according to claim 12, further comprising:
a seat cross member integrally formed with the vehicle floor sheet metal, wherein the seat cross member comprises at least one of
a hollow cross-section, or
at least one of a greater wall thickness or a higher tensile strength than regions adjacent to the seat cross member.

23. The vehicle floor sheet metal arrangement according to claim 12, where a soft region of the vehicle floor sheet metal has a tensile strength of less than 850 MPa.

24. The vehicle floor sheet metal arrangement according to claim 18, wherein the rear seat sheet metal and the vehicle floor sheet metal are integrated in one piece.
